(19) United States
(12) Patent Application Publication
(10) Pub. No.: US 2026/0279046 A1
(43) Pub. Date: Sep. 17, 2026

(54) MULTIMODAL BUG DETECTION IN GAME DEVELOPMENT

(71) Applicant: NVIDIA Corporation, Santa Clara, CA (US)

(72) Inventors: Logan Daniel HERCHE, Ashburn, VA (US); Chi WANG, Shanghai (CN); Hao PENG, Shanghai (CN); David Michael SCHOEMEHL, Chesterfield, MO (US)

(21) Appl. No.: 19/098,487

(22) Filed: Apr. 2, 2025

(30) Foreign Application Priority Data
Mar. 14, 2025 (CN) 2025103123139

(51) Int. Cl. G06V 20/40; G06F 11/3668; G06V 20/70

(52) U.S. Cl. CPC G06V 20/41; G06F 11/3696; G06V 20/49; G06V 20/70

(57) ABSTRACT

In various examples, a game development testing platform is presented that leverages visual language models (VLMs) to identify and analyze bugs within video gameplay. The platform processes captured gameplay video to produce keyframes, representing unique and significant frames. Keyframes may be selected based on computing embedding vectors and dissimilarity scores for individual video frames. The platform may perform keyframe chunking to produce keyframe packets for VLM evaluation. The VLM, provided with keyframe packets and context description prompts, detects bugs within the gameplay video. Additionally, audio inputs may be incorporated for comprehensive analysis. The VLM outputs a structured data object listing detected bugs, which may be consolidated into a comprehensive bug report by a Large Language Model (LLM). This report, augmented with annotated gameplay videos, facilitates efficient bug tracking and resolution and may be integrated with a game developer's bug tracking systems to streamline the debugging process.

### CROSS-REFERENCE TO RELATED APPLICATIONS

This U.S. Patent Application claims priority to, and the benefit of, Chinese Patent Application No. 2025103123139, titled “MULTIMODAL BUG DETECTION IN GAME DEVELOPMENT”, Docket Number 25-RE-0080CN01, filed on Mar. 14, 2025, which is incorporated herein by reference in its entirety.

### BACKGROUND

In the field of video game development, pre-release quality assurance (QA) testing and debugging is performed to identify bugs and other issues that may adversely impact a game on release. Pre-release testing involves a comprehensive evaluation of the game to identify bugs, glitches, or performance issues. Debugging, on the other hand, is the process of diagnosing and fixing these identified issues. Developers use various debugging tools and techniques, such as breakpoints, log analysis, and automated testing scripts, to isolate the root causes of problems and implement effective solutions. Bug tracking systems provide software tools to help development teams identify, record, and manage bugs or other issues in their projects in order to prioritize and assign tasks for fixing the issues. The iterative process of testing and debugging is a requisite stage of video game development to refine gameplay mechanics and enhance stability to produce a polished gaming experience for end users.

### SUMMARY

Embodiments of the present disclosure relate to multimodal bug detection in game development. Systems and methods are disclosed that provide a game development testing platform that applies vision language models (or multimodal language models) to identify bugs from video data (and/or other data) that captures gameplay segments.

In contrast to conventional systems, one or more embodiments of the game development testing platform described herein leverages vision language models (VLMs) to identify and analyze bugs within video gameplay. The game development testing platform may process captured gameplay video to produce keyframes, which represent unique and significant frames where unique events occur. Keyframes may be selected based on computing embedding vectors for video frames of gameplay data and computing dissimilarity scores. By focusing bug detection on video characteristics of keyframes, the platform enhances bug identification while minimizing time and computing resources. In some embodiments, the platform further refines the process by chunking the selected keyframes into keyframe packets, which may then be evaluated for bugs using the VLM. The VLM may be provided with a keyframes packet and a context description prompt that describes, for example, the expected visual perspective, the valid gameplay mechanics, and/or any unique features (e.g., like the ability for players to perform double jumping) that are not considered issues or anomalies. In some embodiments, a context description prompt may include a bug list—a bug class listing and/or descriptions of target anomalies to be detected by the VLM. The VLM's foundational training on real-world data, combined with specific tuning for video game data, allows it to recognize both common and unique bugs within the game's context. Additionally, the platform can incorporate audio as an input to the VLM, enabling the detection of visual issues based on audio context. The output from the VLM is a structured data object listing detected bugs, which may then be consolidated into a comprehensive bug report, for example by a large language model (LLM). This report may be augmented with annotated gameplay videos to facilitate efficient bug tracking and resolution by game developers. The platform may be integrated with a game developer's bug tracking systems to further streamline the debugging process.

### BRIEF DESCRIPTION OF THE DRAWINGS

The present systems and methods for multimodal bug detection in game development are described in detail below with reference to the attached drawing figures, wherein:

FIGS. 1A, 1B, and 1C are data flow diagrams illustrating an example process for visual anomaly detection-based game development testing, in accordance with some embodiments of the present disclosure;

FIG. 2 is a diagram illustrating an example cloud-hosted implementation of a game development testing platform, in accordance with some embodiments of the present disclosure;

FIG. 3 is a flow chart illustrating an example method for visual anomaly detection-based game development testing, in accordance with some embodiments of the present disclosure;

FIG. 4 is a diagram illustrating an example network cloud-based environment architecture for hosting one or more language models, in accordance with some embodiments of the present disclosure;

FIG. 5A is a block diagram of an example generative language model system suitable for use in implementing at least some embodiments of the present disclosure;

FIG. 5B is a block diagram of an example generative language model that includes a transformer encoder-decoder suitable for use in implementing at least some embodiments of the present disclosure;

FIG. 5C is a block diagram of an example generative language model that includes a decoder-only transformer architecture suitable for use in implementing at least some embodiments of the present disclosure;

FIG. 6 is a block diagram of an example computing device suitable for use in implementing at least some embodiments of the present disclosure; and

FIG. 7 is a block diagram of an example data center suitable for use in implementing at least some embodiments of the present disclosure.

### DETAILED DESCRIPTION

Systems and methods are disclosed related to multimodal bug detection in game development. More specifically, one or more embodiments provide for a game development testing platform that applies vision language models (VLMs) (or multimodal language models) to identify bugs from video data (and/or other data) that captures gameplay segments.

Pre-release quality assurance (QA) video game testing often includes performing a stage of testing protocols, such as unit tests and integration tests, followed by a human testing stage. QA testing may create specific scenarios with expected outcomes that test individual game components or interactions between components. For example, unit testing involves isolating and testing individual components or modules of the game, such as specific libraries, algorithms, functions, or classes, to verify that each unit performs as expected. Unit testing thus may be used in the video game development process to catch and address issues at a level that ensures that individual part of the game operates correctly in isolation. Integration testing, on the other hand, focuses on the interactions between such individual units. Integration tests verify that components work together as intended and may involve combining multiple components and testing them as a group to identify any issues that arise from their interactions. These tests may be used in detecting problems related to data flow, interface mismatches, and overall system behavior. Together, unit and integration testing help game designers ensure that both the individual elements and their combined functionality work seamlessly.

Testing protocols, such as unit tests and integration tests are automated and can be performed quickly, but have various shortcomings. For example, each unit and integration test is typically created manually, and the code to implement these tests involve their own code-base development and maintenance costs. There are also practical limits to creating tests that cover all scenarios players can encounter in a game. As an example, unit tests and integration tests generally cover expected logical outcomes but do not detect other issues, like visual or animation problems. Moreover, these automated tests cannot fully replicate the complex and dynamic nature of real-world gameplay. As such, while unit and integration tests are beneficial for identifying and resolving issues at the code and component interaction levels, they are not sufficient on their own to ensure a flawless game experience.

Human testing of video games after (and/or in concert with) pre-release testing may help in identifying bugs that are not found by unit tests and integration tests by introducing the game to a diverse group of players who may interact with the game in a holistic manner and in unpredictable ways to produce unexpected results. Human testing may include human gameplay and/or human review, where a team of human QA testers play the game and/or review in-game flythrough. Human testing often identifies visual anomalies, such as objects misplaced by graphic artists, floating objects, and/or inappropriate collisions or intersections between objects and/or surfaces. Human testing can therefore identify bugs beyond what testing protocols, such as unit tests and integration tests, can cover. These testers report any identified bugs to the bug tracking system where the game designers can attempt to reproduce and correct the issues.

However, as game complexity increases and open-world environments become more prevalent, the effectiveness of unit and integration tests, even when combined with human testing, becomes limited. Unit and integration tests are designed to handle specific, isolated components and their interactions, but they struggle to account for the vast, interconnected systems and emergent behaviors typical of complex, open-world games. These environments often feature dynamic elements, such as artificial intelligence (AI) behavior, player choices, and environmental interactions, which can lead to unpredictable outcomes that automated tests cannot fully anticipate. The effectiveness of human testing also has limitations as games become more complex. For example, the sheer volume of content and potential interactions can overwhelm testers, making it difficult to test every aspect of the game. Additionally, human fatigue can negatively impact the effectiveness of testing, especially during long-duration gaming sessions. Testers may become less attentive and more prone to overlooking issues as they tire, leading to missed bugs and incomplete feedback. This fatigue can be exacerbated by the immersive and demanding nature of many games, where extended play sessions are common. A tester may become either blind or hypersensitive to an issue because they have experienced it so often. Moreover, due to the difficulty of reviewing gameplay for bugs in real-time, limitations of the naked human eye, and reaction speed, human testers are unlikely to find and report all bugs. This may be especially true when a bug is not obvious or when the bug is not present on screen for very long. Additionally, if there are many issues in a scene, human testers are likely to report only the most prevalent bugs. Furthermore, human review is expensive to scale. For example, it would generally be impractical to conduct human review on nightly builds. This is a substantial issue in large open-world games, which may take hundreds of hours to complete when testing all paths through the world.

In contrast to prior game development testing techniques, one or more of the embodiments discussed herein provide a game development testing platform that applies vision language models and/or other models to identify gameplay segments that may contain bugs that produce visually apparent anomalies (e.g., visual anomalies, rendering errors, logical bugs, art issues, etc.). That is, in some embodiments the testing platform leverages vision language models to identify bugs within video gameplay. The testing platform may obtain captured video of gameplay (e.g., captured from human testing of the video game), which may then be processed to produce keyframes. A set of keyframes may be produced that represent the most unique and significant frames from the video where unique events occur. For example, in a video sequence that includes a rendering of a hand moving back and forth, keyframes may include a frame where the hand is at its starting position of the back and forth movement, a frame where the hand is at its ending position of the back and forth movement, and possibly one or more midpoint positions, thus effectively capturing an abridged representation of the motion. In some embodiments, keyframes may be produced by applying the captured gameplay data (e.g., video data) to an embedding model (e.g., a video-captioning machine learning model) to create a vector embedding for individual video frames of the gameplay data. The embedding model is a machine learning model trained to describe what is happening in an image, and to generate a numerical vector embedding representation of that description. A keyframe may thus be extracted from video data as a numerical vector embedding representation. A video data frame may be extracted and designated as a keyframe, for example, based on a dissimilarity (e.g., uniqueness) of its embedding as compared to the embedding of other frames. For example, keyframes may be selected based on computing a numerical score (e.g., a dissimilarity score) between the embedding of the frame in question and the embeddings of other frames in the frame sequence under evaluation. The video frames with the highest scores (e.g., or dissimilarity scores above a keyframe selection threshold) are selected and extracted from the video data as keyframes. The extracted keyframes thus provide a concise yet comprehensive representation of key gameplay moments. The game development testing platform thus enhances the identification and analysis of bugs by focusing on the most relevant frames and avoiding time and computing resource expenses that would be incurred by evaluating each image frame of the video data. Moreover, a bug being present in a video image frame not selected as a keyframe would imply that the bug is not very visually distinct when considered in comparison to the other video frames, and therefore very minor in nature (e.g., not readily discernable during gameplay). That said, in some embodiments, the keyframe selection threshold may be adjusted to tune the amount of dissimilarity for determining what constitutes a keyframe.

In some embodiments, chunking of the selected set of keyframes is performed to distribute the set of keyframes into keyframe packets, each keyframe packet comprising a chunk of sequential keyframes. Chunking may serve to reduce the full set of video data frames to more concise groupings that are more efficiently processed for bug detection. That is, chunking of the set of keyframes creates segments of sequential keyframes, where an individual chunk represents a segment of the video stream. The number of keyframes per chunk can be adjusted based on the nature of the bugs being targeted. For instance, a chunk might consist of 5,000 keyframes or just 10 keyframes, depending on the requirements. In some embodiments, the size of each chunk may be selected based on the VLM's context size, aiming to choose the largest chunk that does not exceed the VLM's capacity. This ensures that the model can process as much of the video's context as possible. In some embodiments, the VLM context size may accommodate a greater number of keyframes for lower-resolution keyframes compared to higher-resolution ones, allowing for flexibility in processing different types of video content. The chunking process determines the segment of the video that will be processed at a given time.

In some embodiments, a series of video chunks may be generated that comprises at least partially overlapping chunks. That is, a first chunk may be formed from a first set of sequential keyframes, and a second chunk may be formed from a second set of sequential keyframes that at least partially overlaps the first set of sequential keyframes.

A chunk of keyframes may then be individually evaluated for bugs using a VLM. The VLM may, in some embodiments, be provided with the following inputs: the chunk of keyframes, a list and/or descriptions of target anomalies to be detected (e.g., what types of bugs the game designers are looking for), and a description of the evaluated game, including expected behaviors. The VLM then analyzes the chunk and produces a list of detected bugs. The list may include, for example, a bug class, a plain text description of the identified bug instances, the location of the bug (which could be a bounding box, a set of points, or a short text description like “red car on the left”), and/or a list of keyframes where the bug is present. When a chunk of keyframes is passed to the VLM, timestamps for the keyframes may also be passed so that the model understands the keyframes in the context of the passage of time.

In some embodiments, the VLM may be passed the chunk of keyframes, their corresponding timestamps, and a detailed context description prompt with a game description. This context description prompt may include a high-level description of the game, particularly highlighting elements that are abnormal or strange compared to real-world scenarios. That is, the VLM may comprise a foundation model that is trained on real-world image data, and then further tuned specifically using video game data. A benefit of using a vision language model is that because the model has foundational training based on real-world information, the model obtains a notion of logic and physics, and most of those rules still apply in most video games. For example, a VLM may thus observe a character floating across a scene rather than walking on a solid surface, and from its training recognize that as a bug. In contrast, some games allow a playable character to double jump, which is not possible in real life and would typically be considered a bug. However, if the game intentionally supports double jumping, then this must be communicated to the model to prevent it from being flagged as a bug. Such are details that may be included in the text description prompt to the VLM. In some embodiments, a text description may describe, for example, the expected visual perspective, the valid gameplay mechanics, and/or any unique features (e.g., like the ability for players to perform double jumping) that are not considered issues. As another example, Cyberpunk 2077 is a first-person action role-playing game (RPG) set in a dystopian cyberpunk world. This setting is characterized by advanced technology, cybernetic enhancements, and a gritty, futuristic atmosphere. In this game, certain visual effects and behaviors are intentionally designed to enhance the immersive experience. For example, characters may appear and disappear with visual artifacting, which is an intended in-game effect to simulate the cybernetic nature of the world, rather than a rendering bug. Additionally, characters in Cyberpunk 2077 can perform actions that defy real-world physics, such as double jumping. These features are not bugs but deliberate design choices that contribute to the unique gameplay experience. The context description prompt input may be used to highlight these intentional elements when describing the game to make sure that they are not mistakenly identified by the VLM as bugs during the evaluation process.

In some embodiments, a bug class listing and the corresponding description of each bug class may be based on prior knowledge of prevalent issues encountered during game development. During the VLM training phase, multiple variants of each bug description may be used to enhance the model's robustness in detecting anomalies. When running in deployment, the VLM may recognize when visual anomalies occur that are outside the predefined bug descriptions of the bug list. For example, when an anomaly is detected that does not match any of the predefined bug descriptions of the bug list, the VLM may classify that bug as an unknown anomaly. Moreover, the bug list itself may be designed to provide classification flexibility. For example, the bug list may include a “no bug” class, a “logical bugs” class for inconsistencies (e.g., an object disappearing and reappearing in a game), and an “other bugs” class for any abnormalities not covered by the other categories.

In some embodiments, the VLM may be provided a list of high-level bug classes and their descriptions. For instance, a bug class might be “collision,” with a description of what a collision looks like in the game. Such information may be provided as an input into the VLM, which then outputs anomaly data in the form of a structured data object (e.g., having a Java Script Object Notation (JSON) object, extensible markup language (XML) file, or other data structure) describing the detected bugs. The structured data object is an anomaly report that may include one or more of, but not limited to, the one or more keyframes where the bug is present, the bug class, and a short text description of the bug (e.g., 1-3 sentences long). In some embodiments, the game development testing platform may further output augmented keyframes that include one or more bounding boxes indicating the region of the image or video frame where visual bugs were found.

To enhance the system's ability to detect visual glitches, in some embodiments audio can be incorporated as an additional input to the VLM. For example, by leveraging a multimodal language model capable of processing images, text, and an audio track corresponding to a chunk of keyframes can be converted into a shared embedding space, similar to how images are processed. While chunking is primarily based on visuals due to their informative nature, the audio for the duration of each chunk is also included to provide a comprehensive analysis. This allows the VLM to detect visual issues based on the audio context for a chunk of keyframes. The process may involve passing the keyframes, their timestamps, and the corresponding audio track into the model, enabling it to identify any discontinuities between the audio and visuals. The model may be trained using multimodal data to recognize various sounds, such as speech or environmental noises, and align them with the visual content.

The structured data object produced for a chunk is essentially a structured data file that lists all the keyframes of the video chunk and lists any incidents of bugs found in each keyframe. Such a file can be complex to navigate, so after processing a set of several chunks, the game development testing platform may generate a comprehensive bug report. To resolve bugs across different chunks and produce a human-readable report, a large language model (LLM) reviews the list of all identified bugs (and their timestamps) and consolidates them into a unified list to produce the comprehensive bug report. Consolidation may include, for example, deduplication of bug data to eliminate duplicate or redundant information from the report. The comprehensive bug report ensures that all detected bugs are accounted for and organized coherently.

In some embodiments, to facilitate human review, an annotated gameplay video may be created, featuring bounding shape overlays (e.g., bounding boxes) for detected bugs, and may include bug text descriptions as subtitles. For example, if there is a floating woman and a floating rock, then the annotated gameplay video may display separate bug descriptions for each, along with the keyframes where these bugs are present and the bounding boxes highlighting their locations. The VLM may output the structured data object for one or more chunks, and the game development testing platform may post-process those structured data objects to produce the comprehensive bug report and the annotated gameplay video. Each bug instance may be annotated with its class, ensuring that every occurrence of a bug is documented individually—making it easier to review and understand the issues.

In some embodiments, the game development testing platform may be integrated with the game developer's bug tracking system to populate the bug tracking system with the bug data from the comprehensive bug report and/or the annotated gameplay video. The bug data may be ingested directly into the bug tracking system, creating entries for all the identified bugs. Human developers can then review these entries, prioritize them, and decide on the appropriate actions to resolve the bugs. This automation streamlines the bug tracking process, making it more efficient and comprehensive.

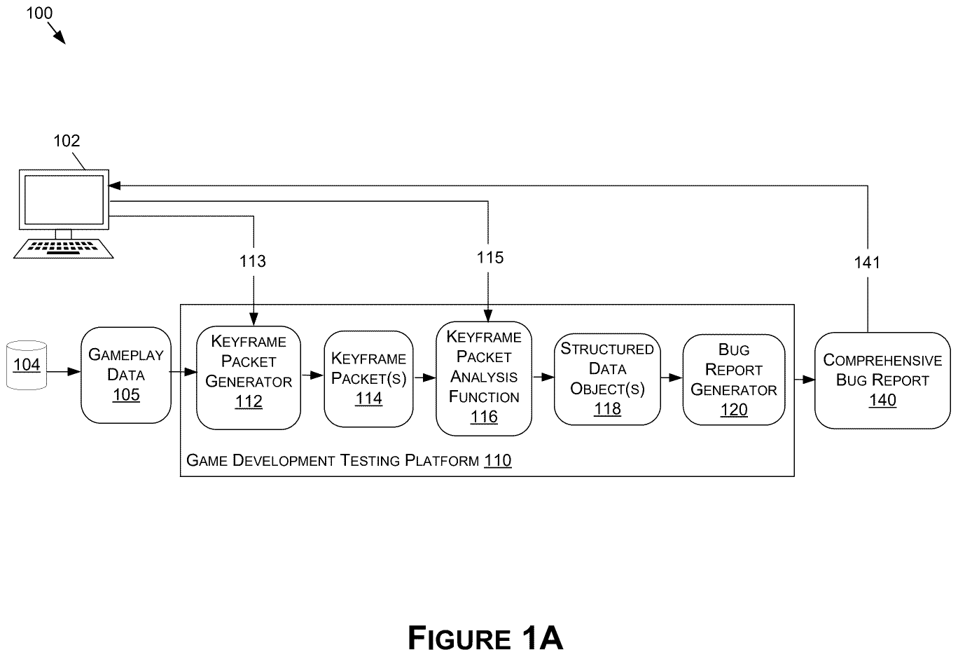

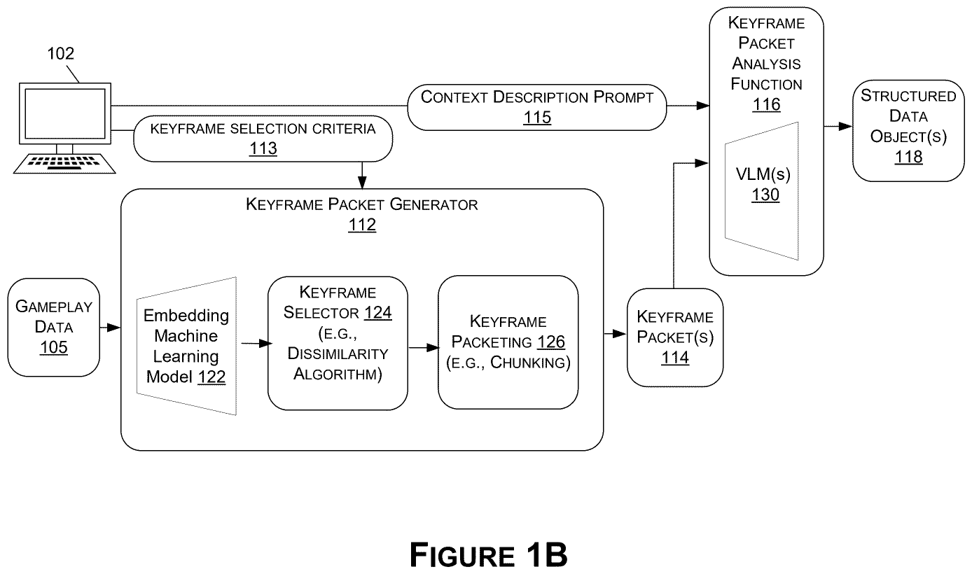

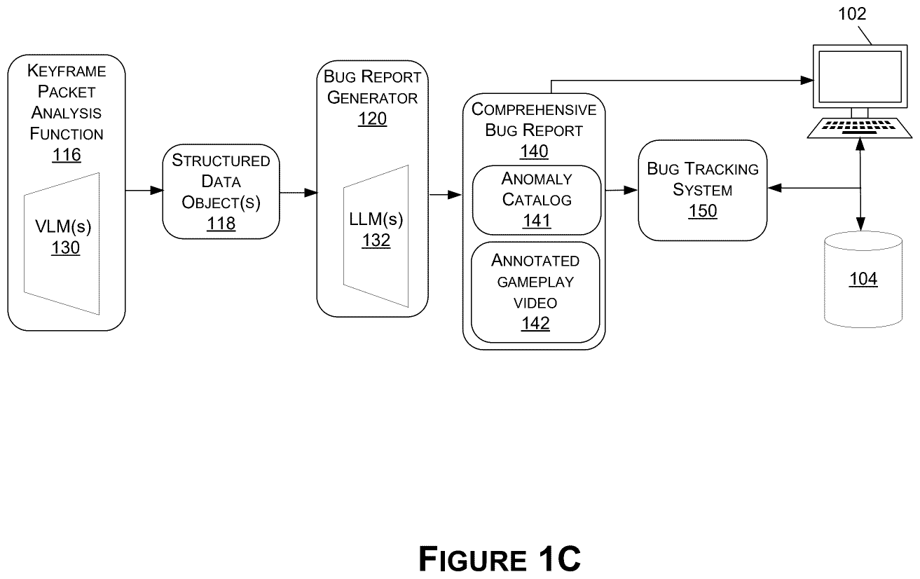

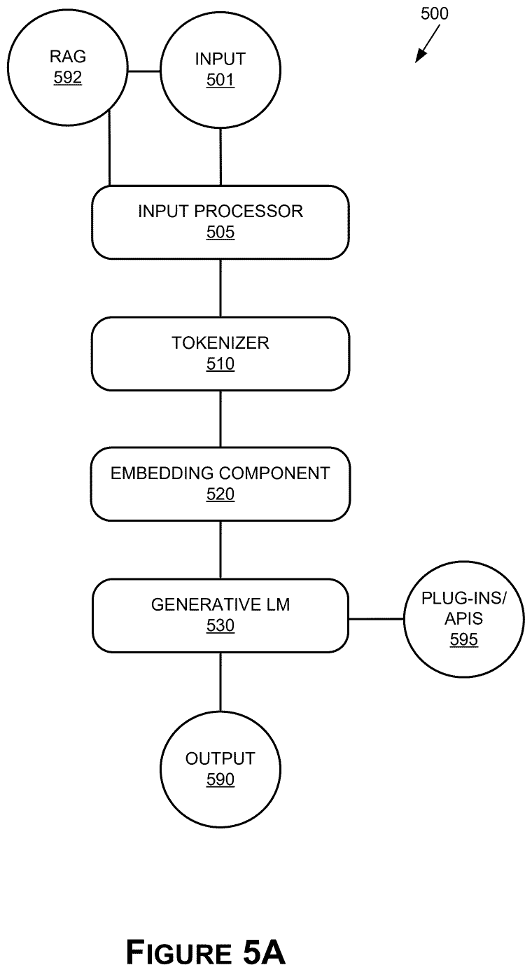

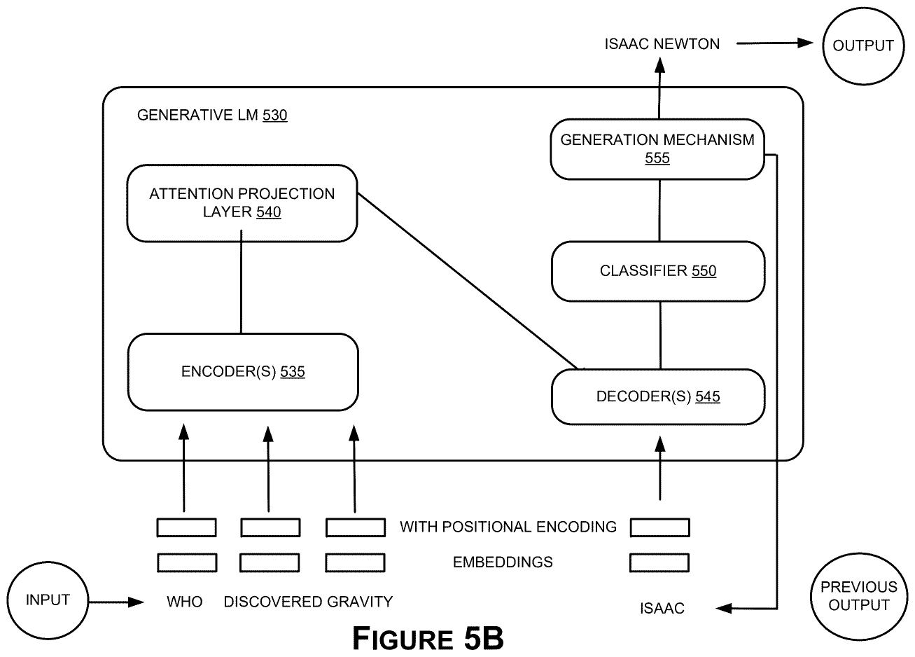

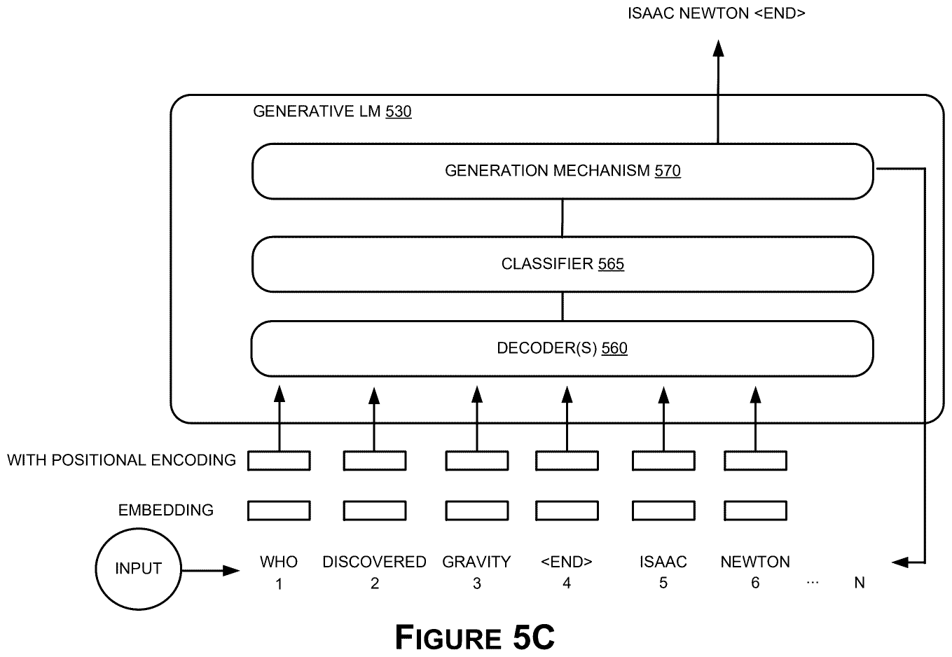

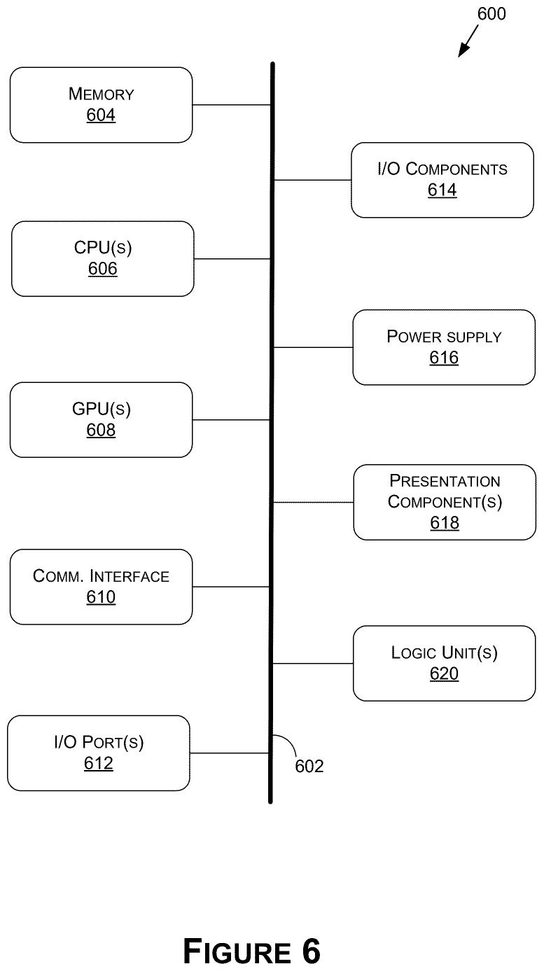

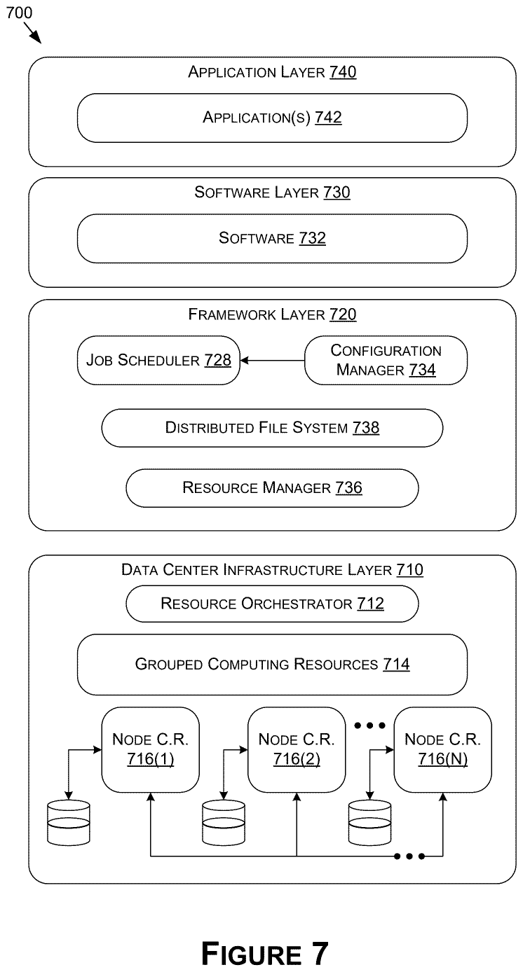

With reference to FIGS. 1A, 1B, and 1C, these figures illustrate example data flow diagrams for a process for visual anomaly detection-based game development testing, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 5A-5C), one or more computing devices or components thereof (e.g., as described in FIG. 6), and/or one or more data centers or components thereof (e.g., as described in FIG. 7).

As shown generally in FIG. 1A at 100, a game development testing platform 110 may evaluate gameplay data 105 based at least on applying visual anomaly detection to video data to generate a bug report 140 that indicates instances of one or more target anomalies for debugging and/or correcting by the game developers. For example, in some embodiments, gameplay data 105, such as video data, may be captured as human testers (e.g., a team of human QA testers) play one or more portions of a video game under development. In some embodiments, gameplay data 105 may include other data, such as audio data, associated with the captured video data. The captured gameplay data 105 may be saved and stored, for example, in a game development database 104, from which it may then be obtained by the game development testing platform 110. In some embodiments, components of the game development testing platform 110 may include a keyframe packet generator 112, a keyframe packet analysis function 116, and a bug report generator 120, each of which is discussed in greater detail with respect to FIGS. 1B and 1C.

In some embodiments, the keyframe packet generator 112 may process the gameplay data 105 to generate one or more keyframe packets 114. The keyframe packet generator 112 selects a set of keyframes from the video data of the gameplay data 105, where the selected keyframes represent the most unique and significant frames where unique events occurred during gameplay. The keyframe packet generator 112 may then perform a chunking of the selected set of keyframes to distribute the set of keyframes into the keyframe packets 114. Each keyframe packet 114 may thus include a chunk of sequential keyframes from the set of keyframes. For example, FIG. 1B is a data flow diagram that in part illustrates an example keyframe packet generator 112. In some embodiments, keyframes may be produced by applying the captured gameplay data 105 (e.g., video data) to an embedding machine learning model 122 to create a vector embedding for individual video frames of the gameplay data 105. The embedding machine learning model 122 may comprise, for example, a video-captioning machine learning model.

The embedding machine learning model 122 is trained to generate an embedding output that describes the scene captured in an image frame, and may generate a numerical vector embedding representation of that description. The vector embedding produced by the embedding machine learning model 122 for individual video frames may be fed to the keyframe selector 124, which may comprise, for example, a dissimilarity algorithm. For example, the keyframe selector 124 may execute the dissimilarity algorithm to compute a score that indicates how dissimilar a vector embedding for a video frame is as compared to the vector embeddings of other video frames. Keyframes may be selected based on computing a numerical score (e.g., a dissimilarity score) between the embedding of the frame in question and the embeddings of other frames in the frame sequence under evaluation. The video frames with the scores indicating the highest dissimilarity (e.g., or dissimilarity scores above a keyframe selection threshold) may be selected by the keyframe selector 124 and extracted from the video data as keyframes. In some embodiments, the keyframe packet generator 112 may receive an input (e.g., via a user terminal 102 from a game design engineer) providing a keyframe selection criteria 113 (e.g., a keyframe selection threshold) that may be adjusted to tune the amount of dissimilarity used by the keyframe selector 124 for determining what constitutes a keyframe.

In some embodiments, chunking of the selected set of keyframes to form keyframe packets 114 may be performed by a keyframe packeting 126 function of the keyframe packet generator 112. The keyframe packeting 126 function distributes the set of keyframes selected by the keyframe selector 124 into keyframe packets 114, such that each keyframe packet 114 comprises a chunk of sequential keyframes. The keyframe packeting 126 thus determines the segment of the gameplay data 105 that will be processed at a given processing iteration by the keyframe packet analysis function 116. In some embodiments, a keyframe packet 114 may further include timestamp information corresponding to the individual keyframes included in that keyframe packet 114.

The number of keyframes per keyframe packet 114 can be adjusted (e.g., via the keyframe selection criteria 113) based on the nature of the bugs being targeted, for example. In some embodiments, the size of each keyframe packet 114 may be selected based on a context size of one or more of the VLM(s) 130 of the keyframe packet analysis function 116. For example, the size of each keyframe packet 114 may be selected as an optimal value such that the VLM(s) 130 can process as much video context as possible—providing the keyframe packet analysis function 116 with a greater notion of the context of the keyframe packet 114 being processed. In some embodiments, a series of keyframe packets 114 may be generated that comprises at least partially overlapping sets of keyframes. That is, a first keyframe packet 114 may be formed from a first set of sequential keyframes, and a second keyframe packet 114 may be formed from a second set of sequential keyframes that at least partially overlaps the first set of sequential keyframes. In some embodiments, to enhance the system's ability to detect visual glitches, the keyframe packets 114 may also carry audio data for an additional input to the keyframe packet analysis function 116 (e.g., to aid VLM(s) 130). By leveraging a multimodal language model capable of processing images, text, and an audio track corresponding to the video data represented by a keyframe packet 114, the keyframes can be converted into a shared embedding space. This may allow the VLM(s) 130 to detect visual issues based on the audio context for a keyframe packet 114. The process may involve passing the keyframes, their timestamps, and the corresponding audio track into the VLM(s) 130. The VLM(s) 130 may be trained using multimodal data to recognize various sounds, such as speech or environmental noises, and align them with the visual content.

In some embodiments, the keyframe packet analysis function 116 may receive the keyframe packet(s) 114 and a detailed context description prompt 115 (e.g., via a user terminal 102), which are provided as input prompts to the VLM(s) 130. The VLM(s) 130 may comprise a foundation model that is trained on real-world image data, and then further tuned specifically using video game data (such as gameplay data 105). This text prompt may include a high-level description of the game, particularly highlighting elements that are abnormal or strange compared to real-world scenarios. In some embodiments, a context description prompt 115 may describe, for example, the expected visual perspective, the valid gameplay mechanics, and/or any unique features (e.g., like the ability for players to perform double jumping) that are not considered issues or anomalies. In some embodiments, a context description prompt 115 may include a bug list—a bug class listing and/or descriptions of target anomalies to be detected (e.g., what types of bugs the game designers are looking for). The bug class listing and the corresponding description of each bug class may be based on prior knowledge of prevalent issues encountered during game development. For instance, a bug class might be “collision,” with a description of what a collision looks like in the game. Multiple variants of each bug description may be used to enhance the robustness of the VLM(s) 130 in detecting the listed target anomalies. In some embodiments, the VLM(s) 130 may recognize and report when visual anomalies occur that are outside the predefined bug descriptions of the bug listing. For example, when an anomaly is detected that does not match any of the predefined bug descriptions of the bug list, the VLM(s) 130 may classify that bug as an unknown anomaly. Moreover, the bug class listing itself may be designed to provide classification flexibility. For example, the bug list may include a “no bug” class, a “logical bugs” class for inconsistencies (e.g., an object disappearing and reappearing in a game), and an “other bugs” class for any abnormalities not covered by the other categories.

The VLM(s) 130 may receive the keyframe packet(s) 114, and based on the context description prompt 115, evaluate the keyframe packet(s) 114 to detect and identify where instances of target anomalies occur within the individual keyframes. Based on the evaluation of one or more keyframe packets 114, the VLM(s) 130 may generate, as anomaly data, one or more structured data object(s) 118. The VLM(s) 130 may comprise a foundation model that is trained on real-world image data, and then further trained specifically using video game data, and therefore is trained to have a notion of logic and physics to be able to recognize visual features that are not conforming to expectations of how those features should appear and/or behave. Visual anomalies may include, but are not limited to, floating objects, inappropriate collisions and/or intersections between objects and/or surfaces, logical inconsistencies, behavior abnormalities (e.g., double jumping)—which may be assessed within the guidance provided by the context description prompt 115 of what may be considered non-anomalies for a given game scenario. The VLM(s) 130 may further classify detected instances of target anomalies within individual keyframes, providing an indication of one or more of the keyframes where the target anomalies occur, the location of the bug (e.g., a bounding box, a set of points, or a short text description like the “red car on the left”), the bug class that applies to the detected instances, or a description of the particular anomaly as it appears in a keyframe.

The one or more structured data object(s) 118 generated by the VLM(s) 130 may comprise a structured data object (e.g., having a JSON object, XML file, or other data structure) describing the detected target anomalies and related information about those anomalies inferred and/or classified by the VLM(s) 130 as described herein. For each keyframe, the structured data object 118 may include one or more of, but not limited to, the one or more keyframes where the bug is present, the bug class, and a short text description of the bug (e.g., 1-3 sentences long).

The one or more structured data object(s) 118 generated by the VLM(s) 130 may be output from the keyframe packet analysis function 116 to the bug report generator 120 to produce the comprehensive bug report 140. In some embodiments, a structured data object 118 produced from a keyframe packet 114 is essentially a structured data file that comprises tables and/or listing representing all the keyframes any detailing incidents of bugs found in each keyframe. Such a file can be large and complex, and particularly difficult for a game developer to parse and fully comprehend. The task may be made more challenging by the fact that the analysis of gameplay data 105 may involve the generation of a plurality of structured data objects 118, each corresponding to one of a plurality of different keyframe packets 114. Therefore, as shown in FIG. 1C, in some embodiments, one or more structured data object(s) 118 may be output to the bug report generator 120 and processed by one or more large language models (LLMs) 132 to produce a human-readable comprehensive bug report 140. To resolve bugs across multiple keyframe packets 114, the LLM(s) 132 may process the anomaly data for the various instances of target anomalies included in multiple structured data objects 118 (e.g., all identified bugs and their timestamps) and consolidates the identified instances into a unified anomaly catalog 141 comprising a listing of the detected bugs (e.g., including their bug classifications, descriptions, anomaly instance keyframe locations, etc.) to produce the comprehensive bug report 140. Consolidation may include, for example, deduplication of bug data to eliminate duplicate or redundant information from the report.

In some embodiments, to facilitate human review, the bug report generator 120 may create and output an annotated gameplay video 142, which may be provided as a component of the comprehensive bug report 140 and/or as a separate file. In some embodiments, the bug report generator 120 may augment the keyframes from the keyframe packet 114, for example adding bounding shape overlays (e.g., bounding boxes) over detected bug instances and/or bug text descriptions as subtitles. Such augmentations may be created, for example, by a generative AI model based on anomaly data included in a structured data object 118. In some embodiments, separate augmentations may be generated on a keyframe for each anomaly instance detected on that keyframe. For example, if detected anomalies within a keyframe include a floating woman and a floating rock, the annotated gameplay video 142 may display separate bug descriptions, annotations, and/or bounding shapes for each, and/or may indicate other keyframes where these bug classes are present. In some embodiments, the comprehensive bug report 140 (including the anomaly catalog 141 and/or the annotated gameplay video 142), may be accessed and viewed via a user terminal 102 and/or saved to the game development database 104.

As shown in FIG. 1C, in some embodiments, the game development testing platform 110 may be integrated with the game developer's bug tracking system 150. For example, the game development testing platform 110 may populate the bug tracking system 150 with the data from the comprehensive bug report 140 (including the anomaly catalog 141 and/or annotated gameplay video 142). The data may be ingested directly into the bug tracking system 150, creating entries for each instance of identified target anomalies comprehensive bug report 140. The game developers may then review these entries by accessing the bug tracking system 150 (e.g., via a user terminal 102), prioritize them, and decide on the appropriate actions to resolve the bugs.

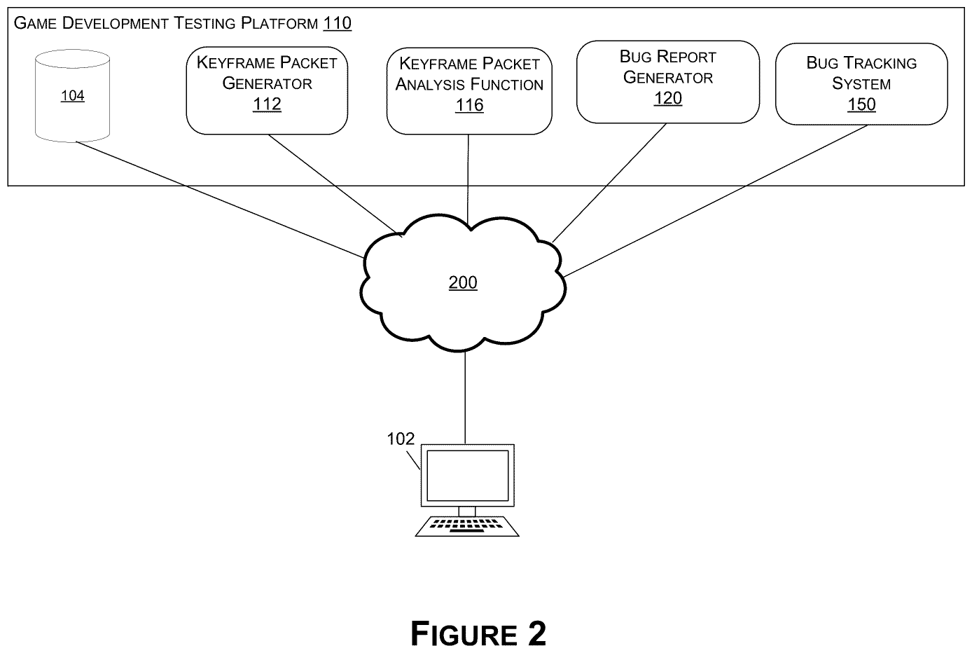

FIG. 2 is a diagram of an example cloud-hosted implementation of the game development testing platform 110. As shown in FIG. 2, one or more elements of the game development testing platform 110 may be individually implemented as one or more cloud-hosted microservices that are accessible, for example, to a game developer user of user terminal 102 via a network 200. Moreover, two or more of these elements may interact with each other as described herein via the network 200. In some embodiments, one or more microservices may be exposed for access to the user terminal 102, for example, through application programming interface (API) calls and/or hypertext transfer protocols (HTTP).

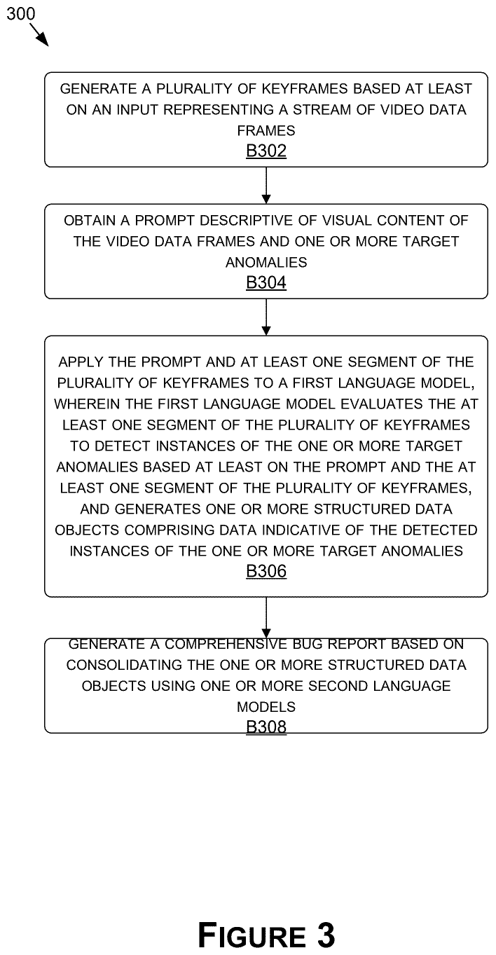

Now referring to FIG. 3, FIG. 3 is a flow diagram showing a method 300 for visual anomaly detection-based game development testing, in accordance with some embodiments of the present disclosure. It should be understood that the features and elements described herein with respect to the method 300 of FIG. 3 may be used in conjunction with, in combination with, or substituted for elements of any of the other embodiments discussed herein and vice versa. Further, it should be understood that the functions, structures, and other descriptions of elements for embodiments described in FIG. 3 may apply to like or similarly named or described elements across any of the figures and/or embodiments described herein and vice versa.

Each block of method 300, described herein, comprises a computing process that may be performed using any combination of hardware, firmware, and/or software. For instance, various functions may be carried out by one or more processors (e.g., one or more processing units comprising processing circuitry) executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 300 is described, by way of example, with respect to the game development testing platform 110 of FIG. 1. However, these methods may additionally or alternatively be executed by any one system, or any combination of systems, including, but not limited to, those described herein.

As discussed herein in greater detail, the method may in general include: generating an output indicative of instances of one or more target anomalies occurring in a stream of video data frames, the output generated based at least on: processing at least one segment of a plurality of keyframes associated with the stream, using at least one language model, to detect instances of one or more target anomalies based at least on a prompt descriptive of visual content of the video data frames; generating at least one structured data object comprising data indicative of the detected instances of the one or more target anomalies; and generating the output based at least on processing the at least one structured data object using the at least one language model.

The method 300, at block B302, includes generating a plurality of keyframes based at least on an input representing a stream of video data frames. The stream of video data frames may be obtained based at least on images of video game gameplay. For example, in some embodiments, gameplay data 105, such as video data, may be captured as human testers (e.g., a team of human QA testers) play one or more portions of a video game under development. In some embodiments, gameplay data 105 may include other data, such as audio data, associated with the captured video data. The plurality of keyframes may be generated based at least on applying the stream of video data frames to an embedding model to compute a plurality of numerical vector embeddings, and applying a similarity algorithm to the plurality of numerical vector embeddings to detect individual numerical vector embeddings having a dissimilarity that exceeds a keyframe selection threshold. In some embodiments, the embedding model comprises a video-captioning machine learning model trained to describe one or more aspects of a scene represented by a video data frame. In some embodiments, the at least one segment of the plurality of keyframes may be generated based at least on generating one or more partially overlapping segments of the plurality of keyframes. For example, a series of keyframe packets 114 may be generated that comprises at least partially overlapping sets of keyframes. A first keyframe packet 114 may be formed from a first set of sequential keyframes, and a second keyframe packet 114 may be formed from a second set of sequential keyframes that at least partially overlaps the first set of sequential keyframes.

The method 300, at block B304, includes obtaining a prompt descriptive of visual content of the video data frames and one or more target anomalies. In some embodiments, the prompt comprises a class listing associated with the one or more target anomalies, where the class listing may include a first classification indicating when no anomaly is detected and a second classification indicating when an anomaly is detected and not covered by other target anomalies. For example, in some embodiments, the keyframe packet analysis function 116 may receive the keyframe packet(s) 114 and a detailed context description prompt 115 (e.g., via a user terminal 102) that are provided as input prompts to the VLM(s) 130. In some embodiments, a context description prompt 115 may describe, for example, the expected visual perspective, the valid gameplay mechanics, and/or any unique features (e.g., like the ability for players to perform double jumping) that are not considered issues or anomalies. In some embodiments, a context description prompt 115 may include a bug list—a bug class listing and/or descriptions of target anomalies to be detected (e.g., what types of bugs the game designers are looking for). The bug class listing and the corresponding description of each bug class may be based on prior knowledge of prevalent issues encountered during game development.

The method 300, at block B306, includes applying the prompt and at least one segment of the plurality of keyframes to a first language model, wherein the first language model evaluates the at least one segment of the plurality of keyframes to detect instances of the one or more target anomalies based at least on the prompt and the at least one segment of the plurality of keyframes, and generates one or more structured data objects comprising data indicative of the detected instances of the one or more target anomalies. The input to the first language model may comprise one or more timestamps corresponding to respective keyframes of the plurality of keyframes.

For example, as discussed herein, the VLM(s) 130 may receive the keyframe packet(s) 114, and based on the context description prompt 115, evaluates the keyframe packet(s) 114 to detect and identify where instances of target anomalies occur within the individual keyframes. Based on the evaluation of one or more keyframe packets 114, the VLM(s) 130 may generate, as anomaly data, one or more structured data object(s) 118. The VLM(s) 130 may further classify detected instances of target anomalies within individual keyframes, providing an indication of one or more of the keyframes where the target anomalies occur, the location of the bug (e.g., a bounding box, a set of points, or a short text description like the “red car on the left”), the bug class that applies to the detected instances, and a description of the particular anomaly as it appears in a keyframe.

The one or more structured data objects may be generated based at least on a JSON object or an XML file that includes the data indicative of the one or more target anomalies correlated to respective individual keyframes for individual segments of the at least one segment. For example, the one or more structured data object(s) 118 generated by the VLM(s) 130 may comprise a structured data object (e.g., having a JSON object, XML file, or other data structure) describing the detected target anomalies and related information about those anomalies inferred and/or classified by the VLM(s) 130 as described herein. For each keyframe, the structured data object 118 may include one or more of, but not limited to, the one or more keyframes where the bug is present, the bug class, and a short text description of the bug (e.g., 1-3 sentences long).

The at least one segment of the plurality of keyframes may be generated based at least on a context size of the first language model. For example, the number of keyframes per keyframe packet 114 can be adjusted (e.g., via the keyframe selection criteria 113) based on the nature of the bugs being targeted, for example. In some embodiments, the size of each keyframe packet 114 may be selected based on a context size of one or more of the VLM(s) 130 of the keyframe packet analysis function 116. For example, the size of each keyframe packet 114 may be selected as an optimal value such that the VLM(s) 130 can process as much video context as possible—providing the keyframe packet analysis function 116 with a greater notion of the context of the keyframe packet 114 being processed.

In some embodiments, the input to the first language model further comprises audio data associated with the at least one segment of the plurality of keyframes. For example, to enhance the system's ability to detect visual glitches, the keyframe packets 114 may also carry audio data for an additional input to the keyframe packet analysis function 116 (e.g., to aid VLM(s) 130). By leveraging a multimodal language model capable of processing images, text, and an audio track corresponding to the video data represented by a keyframe packet 114, the keyframes can be converted into a shared embedding space. This may allow the VLM(s) 130 to detect visual issues based on the audio context for a keyframe packet 114. The process may involve passing the keyframes, their timestamps, and the corresponding audio track into the VLM(s) 130. The VLM(s) 130 may be trained using multimodal data to recognize various sounds, such as speech or environmental noises, and align them with the visual content.

The method may further generate, based at least on the stream of video data frames and the one or more structured data objects, annotated video comprising one or more bounding shape overlays indicating the detected instances of the one or more target anomalies. For example, the bug report generator 120 may augment the keyframes from the keyframe packet 114, for example adding bounding shape overlays (e.g., bounding boxes) over detected bug instances and/or bug text descriptions as subtitles. Such augmentations may be created, for example, by a generative AI model based on anomaly data included in a structured data object 118. In some embodiments, separate augmentations may be generated on a keyframe for each anomaly instance detected on that keyframe. For example, if detected anomalies within a keyframe include a floating woman and a floating rock, the annotated gameplay video 142 may display separate bug descriptions, annotations, and/or bounding shapes for each, and/or may indicate other keyframes where these bug classes are present. In some embodiments, the comprehensive bug report 140 (including the anomaly catalog 141 and/or annotated gameplay video 142), may be accessed and viewed via a user terminal 102 and/or saved to the game development database 104.

The method 300, at block B308, includes generating a comprehensive bug report based on consolidating the one or more structured data objects using one or more second language models. The one or more structured data object(s) 118 generated by the VLM(s) 130 may be output from the keyframe packet analysis function 116 to the bug report generator 120 to produce the comprehensive bug report 140. A structured data object 118 produced from a keyframe packet 114 is essentially a structured data file comprising tables and/or listings that represent all the keyframes and detailing incidents of bugs found in each keyframe. Such a file can be large and complex, and particularly difficult for a game developer to parse and fully comprehend. The task may be made more challenging by the fact that the analysis of gameplay data 105 may involve the generation of a plurality of structured data objects 118, each corresponding to one of a plurality of different keyframe packets 114. Therefore, as shown in FIG. 1C, in some embodiments, one or more structured data object(s) 118 may be output to the bug report generator 120 and processed by one or more large language models (LLMs) 132 to produce a human-readable comprehensive bug report 140. To resolve bugs across multiple keyframe packets 114, the LLM(s) 132 may process the anomaly data for the various instances of target anomalies included in multiple structured data objects 118 (e.g., all identified bugs and their timestamps) and consolidates the identified instances into a unified anomaly catalog 141 comprising a listing of the detected bugs (e.g., including their bug classifications, descriptions, anomaly instance keyframe locations, etc.) to produce the comprehensive bug report 140. Consolidation may include, for example, deduplication of bug data to eliminate duplicate or redundant information from the report.

In some embodiments, an output may be generated to an anomaly tracking database to update one or more records of the anomaly tracking database based at least on the comprehensive bug report. For example, in some embodiments, the game development testing platform 110 may be integrated with an anomaly tracking database, such as the game developer's bug tracking system 150. The game development testing platform 110 may populate the bug tracking system 150 with the data from the comprehensive bug report 140 (including the anomaly catalog 141 and/or annotated gameplay video 142). The data may be ingested directly into the bug tracking system 150, creating entries for each instance of identified target anomalies comprehensive bug report 140. The game developers may then review these entries by accessing the bug tracking system 150 (e.g., via a user terminal 102), prioritize them, and decide on the appropriate actions to resolve the bugs.

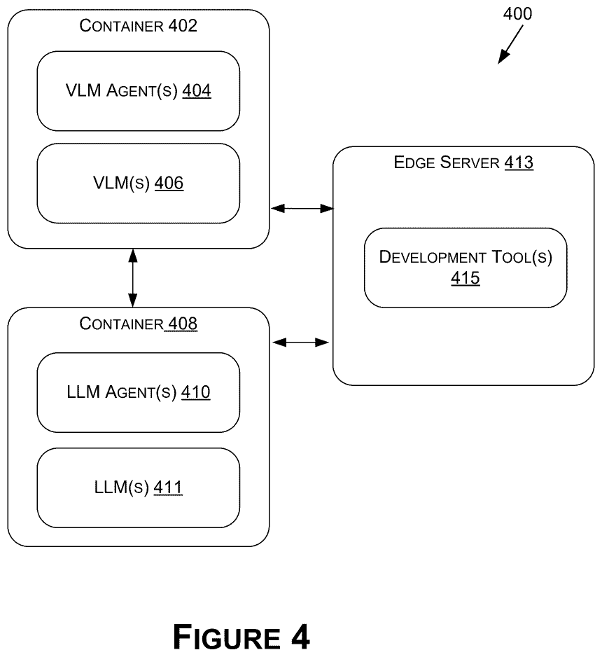

FIG. 4 is a block diagram of an example architecture 400 that illustrates where one or more language model agents (e.g., large language model (LLM), small language model (SLM), vision language model (VLM), multimodal language model (MMLM), etc., agents) and one or more language models (e.g., LLMs, SLMs, VLMs, MMLMs, etc.) may be hosted in a network cloud-based environment, according to some embodiments. The container 402 includes at least one VLM agent 404 and one or more VLMs 406. In some embodiments, the VLMs 406 may comprise one or more of the VLM(s) 130 of the game development testing platform 110. The container 408 includes at least one LLM agent 410 and one or more LLMs 411. In some embodiments, the LLMs 411 may comprise one or more of the LLM(s) 132 of the game development testing platform 110. The edge server 413 may include, for example, one or more development tools 415, which may host applications to implement one or more functions of the game development testing platform 110 discussed herein. Each one of these components is communicatively coupled. In some embodiments, a “container” is an operating system (OS)-level virtualization package that encapsulates an entire microservice, including the API layer, server layer, runtime layer, and/or model engine. Containers are lightweight and portable, making it easier to deploy across different environments. One or more containers may be included in any suitable physical host or computing device, such as one or more machines in a data center, cloud servers, edge servers, or on-premises servers. In some embodiments, one or more components of the architecture 400 of FIG. 4 is hosted at the computing device as described with respect to FIG. 6 and/or the datacenter as described with respect to FIG. 7.

In some embodiments, the edge server 413 may include a server that resides closer to the end user or device in a network (e.g., user terminal 102), typically outside of a centralized data center or cloud infrastructure. Its role is to reduce latency and improve performance by processing data or delivering content closer to where it is generated or consumed. Edge servers are a component of edge computing, which aims to bring computation and data storage closer to the physical location of the user or data source. Since edge servers are closer to the source of data (e.g., sensors, internet-of-things (IoT) devices, or user devices), they can process data in near real-time, which is useful for time-sensitive applications like autonomous driving, augmented reality (AR), or industrial automation. It is understood that although the system architecture 400 illustrates a specific architecture setup, any other combination may be realized. In some embodiments, the development tool(s) 415 are additionally or alternatively hosted within the container 402 or the container 408. In some embodiments, other machine learning models to implement the game development testing platform 110 discussed herein may be hosted within the container 402, container 408, or other container.

In some embodiments, each of the VLM(s) 406, VLM agent 404, LLM(s) 411, LLM agent 410, (and/or any other model) may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the language models (e.g., weights and biases). In some instances, such as where the model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In such embodiments, the model may be accessible via one or more APIs—e.g., representational state transfer (REST) APIs. As such, and in some embodiments, the models and/or agents described herein may be deployed as one or more inference microservices to accelerate deployment of models on any cloud, data center, or edge computing system, while ensuring the data is secure. For example, the inference microservice may include one or more APIs, a preconfigured container for simplified deployment, an optimized inference engine (e.g., built using a standardized AI model deployment and execution software, such as NVIDIA's Triton Inference Server, and/or one or more APIs for high-performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data-center scale). As such, the inference microservice may include the model(s) (e.g., that has been optimized for high-performance inference), an inference runtime software to execute the model(s) and provide outputs/responses to inputs (e.g., generated code, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR) content, virtual reality (VR) content, mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments, for example for the embedding machine learning model 122, VLM(s) 130 and/or LLM(s) 132. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented, for the various embodiments described herein, depending on the particular embodiment and the task(s) being performed using the LLMs/SLMs/VLMs/MMLMs/etc.

In various embodiments, the LLMs/SLMs/VLMs/MMLMs/etc. (e.g., VLM(s) 130, LLM(s) 132) may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 5A is a block diagram of an example generative language model system 500 suitable for use in implementing at least some embodiments of the present disclosure. In some embodiments, one or more of the VLM(s) 130 and/or LLM(s) 132) may be implemented, at least in part, based on the generative language model system 500 as described with respect to FIGS. 5A-5C.

In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which may include an LLM, a SLM, a VLM, a multi-modal LM, etc.).

At a high level, the input processor 505 may receive an input 501 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 530 (e.g., LLM/SLM/VLM/MMLM/etc.). For example, an input 501 may comprise video and/or audio elements of gameplay data 105, and/or a context description prompt 115. In some embodiments, the input 501 includes plain text in the form of one or more sentences, paragraphs, and/or documents. Additionally or alternatively, the input 501 may include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 may combine text (or may omit text) with image data, audio data, video data, design data, USD data, and/or other types of input data, such as but not limited to those described herein. Taking raw input text as an example, the input processor 505 may prepare raw input text in various ways. For example, the input processor 505 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 may remove stopwords to reduce noise and focus the generative LM 530 on more meaningful content. The input processor 505 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 592 (which may include one or more RAG models, and/or may be performed using the generative LM 530 itself) may be used to retrieve additional information to be used as part of the input 501 or prompt. RAG may be used to enhance the input to the LLM/SLM/VLM/MMLM/etc. with external knowledge, so that answers to specific questions or queries or requests are more relevant—such as in a case where specific knowledge is required. The RAG component 592 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 501 may be generated using the query or input to the model (e.g., a question, a request, etc.) in addition to data retrieved using the RAG component 592. In some embodiments, the input processor 505 may analyze the input 501 and communicate with the RAG component 592 (or the RAG component 592 may be part of the input processor 505, in embodiments) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 may retrieve a prior stored conversation history—or at least a summary thereof—and include the prior conversation history along with the current ask/request as part of the input 501 to the generative LM 530.

The RAG component 592 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 592 and the embeddings of the chunks along with the embeddings of the query may be compared to identify the most similar/related embeddings to the query, which may be supplied to the generative LM 530 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 592 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 510 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy may depend on factors such as the language being processed, the task at hand, and/or characteristics of the training dataset. As such, the tokenizer 510 may convert the (e.g., processed) text into a structured format according to tokenization schema being implemented in the particular embodiment.

The embedding component 520 may use any known embedding technique to transform discrete tokens into (e.g., dense, continuous vector) representations of semantic meaning. For example, the embedding component 520 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 505 may resize the data to a standard size compatible with format of a corresponding input channel and/or may normalize pixel values to a common range (e.g., 0 to 1) to ensure a consistent representation, and the embedding component 520 may encode the image data using any known technique (e.g., using one or more convolutional neural networks (CNNs) to extract visual features). In some implementations in which the input 501 includes audio data, the input processor 505 may resample an audio file to a consistent sampling rate for uniform processing, and the embedding component 520 may use any known technique to extract and encode audio features—such as in the form of a spectrogram (e.g., a mel-spectrogram). In some implementations in which the input 501 includes video data, the input processor 505 may extract frames or apply resizing to extracted frames, and the embedding component 520 may extract features such as optical flow embeddings or video embeddings and/or may encode temporal information or sequences of frames. In some implementations in which the input 501 includes multi-modal data, the embedding component 520 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 may use different types of neural network architectures depending on the implementation. In some embodiments, VLM(s) 130 and/or LLM(s) 132 may comprise generative LM 530. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 may apply an encoded representation of the input 501 to the generative LM 530, and the generative LM 530 may process the encoded representation of the input 501 to generate an output 590, which may include responsive text and/or other types of data.

As described herein, in some embodiments, the generative LM 530 may be configured to access or use—or capable of accessing or using—plug-ins/APIs 595 (which may include one or more plug-ins, application programming interfaces (APIs), databases, data stores, repositories, etc.). For example, for certain tasks or operations that the generative LM 530 is not ideally suited for, the model may have instructions (e.g., as a result of training, and/or based on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 595 to the plug-in/API 595, the plug-in/API 595 may process the information and return an answer to the generative LM 530, and the generative LM 530 may use the response to generate the output 590. This process may be repeated—e.g., recursively—for any number of iterations and using any number of plug-ins/APIs 595 until an output 590 that addresses each ask/question/request/process/operation/etc. from the input 501 can be generated. As such, the model(s) may not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. For example, assume input text such as “Who discovered gravity” is tokenized (e.g., by the tokenizer 510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 540 may convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 may generate a first token, and the generation mechanism 555 may apply the generated token as an input during a second pass. The process may repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 may output some decoded (e.g., vector) representation of the input being applied during a particular pass. The classifier 550 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 may select or sample a word or token based on a corresponding predicted probability (e.g., select the word with the highest predicted probability) and append it to the output from a previous pass, generating each word or token sequentially. The generation mechanism 555 may repeat the process, triggering successive decoder inputs and corresponding predictions until selecting or sampling a symbol or token that represents the end of the response, at which point, the generation mechanism 555 may output the generated response.

FIG. 5C is a block diagram of an example implementation in which the generative LM 530 includes a decoder-only transformer architecture. For example, the decoder(s) 560 of FIG. 5C may operate similarly as the decoder(s) 545 of FIG. 5B except each of the decoder(s) 560 of FIG. 5C omits the encoder-decoder self-attention layer (since there is no encoder in this implementation). As such, the decoder(s) 560 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 560. As with the decoder(s) 545 of FIG. 5B, each token (e.g., word) may flow through a separate path in the decoder(s) 560, and the decoder(s) 560, a classifier 565, and a generation mechanism 570 may use auto-regression to sequentially generate one token at a time until predicting a symbol or token that represents the end of the response. The classifier 565 and the generation mechanism 570 may operate similarly as the classifier 550 and the generation mechanism 555 of FIG. 5B, with the generation mechanism 570 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, one or more elements of the game development testing platform 110 may be performed by computing device(s) 600.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared, and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes, and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608. In some embodiments, one or more functions of the game development testing platform 110 may be performed by code executed on one or more of the CPU(s) 606, GPU(s) 608, and/or logic units 620. For example, in some embodiments, one or more of the embedding machine learning model 122, VLM(s) 130, LLM(s) 132, and/or other models of the game development testing platform 110 may be performed by a machine learning architecture executed on GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, user terminal 102 may comprise one or more of presentation component(s) 618.

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740. In some embodiments, one or more functions of the game development testing platform 110 may be performed by one or more systems hosted by data center 700.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination. In some embodiments, one or more functions of the game development testing platform 110 described herein may be executed by the one or more C.R.s 716(1)-716(N).

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources. In some embodiments, one or more functions of the game development testing platform 110 described herein may be performed by application(s) 742 and/or software 732.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate a plurality of keyframes based at least on an input representing a stream of video data frames;
obtain a prompt descriptive of visual content of the video data frames and one or more target anomalies;
apply the prompt and at least one segment of the plurality of keyframes to a first language model, wherein the first language model evaluates the at least one segment of the plurality of keyframes to detect instances of the one or more target anomalies based at least on the prompt and the at least one segment of the plurality of keyframes, and generates one or more structured data objects comprising data indicative of the detected instances of the one or more target anomalies; and
generate a comprehensive bug report based on consolidating the one or more structured data objects using one or more second language models.

2. The one or more processors of claim 1, wherein the processing circuitry is further to obtain the stream of video data frames based at least on images of video game gameplay.

3. The one or more processors of claim 1, wherein the processing circuitry is further to generate the plurality of keyframes based at least on applying the stream of video data frames to an embedding model to compute a plurality of numerical vector embeddings, and applying a similarity algorithm to the plurality of numerical vector embeddings to detect individual numerical vector embeddings having a dissimilarity that exceeds a keyframe selection threshold.

4. The one or more processors of claim 3, wherein the embedding model comprises a video-captioning machine learning model trained to describe one or more aspects of a scene represented by a video data frame.

5. The one or more processors of claim 1, wherein the processing circuitry is further to generate the at least one segment of the plurality of keyframes based at least on a context size of the first language model.

6. The one or more processors of claim 1, wherein the processing circuitry is further to generate the at least one segment of the plurality of keyframes based at least on generating one or more partially overlapping segments of the plurality of keyframes.

7. The one or more processors of claim 1, wherein the input to the first language model further comprises one or more timestamps corresponding to respective keyframes of the plurality of keyframes.

8. The one or more processors of claim 1, wherein the input to the language model further comprises audio data associated with the at least one segment of the plurality of keyframes.

9. The one or more processors of claim 1, wherein the processing circuitry is further to generate the one or more structured data objects based at least on a JSON object or an XML file that includes the data indicative of the one or more target anomalies correlated to respective individual keyframes for individual segments of the at least one segment.

10. The one or more processors of claim 1, wherein the processing circuitry is further to generate, based at least on the stream of video data frames and the one or more structured data objects, annotated video comprising one or more bounding shape overlays indicating the detected instances of the one or more target anomalies.

11. The one or more processors of claim 1, wherein the processing circuitry is further to generate an output to an anomaly tracking database to update one or more records of the anomaly tracking database based at least on the comprehensive bug report.

12. The one or more processors of claim 1, wherein the prompt comprises a class listing associated with the one or more target anomalies, where the class listing may include a first classification indicating when no anomaly is detected and a second classification indicating when an anomaly is detected and not covered by other target anomalies.

13. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system for generating or presenting virtual reality (VR) content;
a system for generating or presenting augmented reality (AR) content;
a system for generating or presenting mixed reality (MR) content;
a system implemented using a robot;
a system for performing conversational AI operations;
a system implementing one or more language models;
a system implementing one or more large language models (LLMs);
a system implementing one or more vision language models (VLMs);
a system implementing one or more small language models (SLMs);
a system implementing one or more multimodal language models (MMLMs);
a system implemented using one or more cloud-hosted microservices;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

14. A system comprising one or more processors to:
obtain a plurality of keyframes based at least on gameplay data comprising video data frames;
process at least one segment of the plurality of keyframes, using at least one language model, to detect instances of one or more target anomalies based at least on a prompt descriptive of visual content of the video data frames and the one or more target anomalies;
generate at least one structured data object comprising data indicative of the detected instances of the one or more target anomalies; and
generate a bug report based at least on the at least one structured data object using the at least one language model.

15. The system of claim 14, wherein the one or more processors are further to generate the plurality of keyframes based at least on applying the stream of video data frames to an embedding model to compute a plurality of numerical vector embeddings, and apply a similarity algorithm to the plurality of numerical vector embeddings to detect individual numerical vector embeddings having a dissimilarity that exceeds a keyframe selection threshold.

16. The system of claim 14, wherein the one or more processors are further to generate, based at least on the stream of video data frames and the at least one structured data object, annotated video comprising one or more bounding shape overlays indicating the detected instances of the one or more target anomalies.

17. The system of claim 14, wherein the one or more processors are further to generate the at least one structured data object based at least on correlating the data indicative of the one or more target anomalies to respective individual keyframes for individual segments of the at least one segment.

18. The system of claim 14, wherein the at least one language model detects the instances of one or more target anomalies further based at least on one or more timestamps corresponding to respective keyframes of the plurality of keyframes.

19. The system of claim 14, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system for generating or presenting virtual reality (VR) content;
a system for generating or presenting augmented reality (AR) content;
a system for generating or presenting mixed reality (MR) content;
a system implemented using a robot;
a system for performing conversational AI operations;
a system implementing one or more language models;
a system implementing one or more large language models (LLMs);
a system implementing one or more vision language models (VLMs);
a system implementing one or more small language models (SLMs);
a system implementing one or more multimodal language models (MMLMs);
a system implemented using one or more cloud-hosted microservices;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
generating an output indicative of instances of one or more target anomalies occurring in a stream of video data frames, the output generated based at least on:
processing at least one segment of a plurality of keyframes associated with the stream, using at least one language model, to detect instances of one or more target anomalies based at least on a prompt descriptive of visual content of the video data frames;
generating at least one structured data object comprising data indicative of the detected instances of the one or more target anomalies; and
generating the output based at least on processing the at least one structured data object using the at least one language model.
